(19) United States
(12) Patent Application Publication
(10) Pub. No.: US 2024/0070661 A1
(43) Pub. Date: Feb. 29, 2024

(54) TRANSACTION SYSTEM TRANSFER TECHNIQUES

(71) Applicant: Truist Bank, Charlotte, NC (US)

(72) Inventors: Manikandan Dhanabalan, Cumming, GA (US); Raghavendra P. Narasimhan, Cary, NC (US); Murali Sethuraman, Suwanee, GA (US)

(73) Assignee: Truist Bank, Charlotte, NC (US)

(21) Appl. No.: 17/895,630

(22) Filed: Aug. 25, 2022

(51) Int. Cl. G06Q 20/38; G06Q 20/40

(52) U.S. Cl. CPC G06Q 20/389; G06Q 20/401; G06Q 20/407

(57) ABSTRACT

A non-transitory computer-readable medium can include instructions that are executable by a processing device for causing the processing device to perform operations. The operations can include receiving, by a first processing network, transaction information associated with one or more transactions of a first type from a transaction medium system, where the transaction information can be obtained by the transaction medium system from an acquirer at a transaction facilitator. Additionally, the operations can include determining that a transaction medium associated with the one or more transactions of the first type has migrated from the first processing network to a second processing network. The transaction information of the first type can be transferred by the first processing network to a second transaction system in the second processing network. The second transaction system can complete the one or more transactions for the first type.

### TECHNICAL FIELD

The present disclosure relates generally to transaction systems and, more particularly (although not necessarily exclusively), to transaction system transfer techniques.

### BACKGROUND

Transaction conversions can be inefficient and inconvenient for a transaction user. The transaction conversions can occur because of a merger, an acquisition, or other suitable change to operation structures of companies. The transaction conversions may include deactivating a first transaction system and implementing a second transaction system. Doing so can impact transaction access for users of the transaction payment systems while the transaction conversion is implemented and can increase workloads for user support centers.

### SUMMARY

In one example, a non-transitory computer-readable medium is described having stored therein instructions that are executable for performing operations. The operations include receiving transaction information associated with one or more transactions of a first type by a first processing network from a transaction medium system, where the transaction information is obtained by the transaction medium system from an acquirer at a transaction facilitator. Additionally, the operations include determining that the transaction medium has migrated from the first processing network to a second processing network. Further, the operations include transferring the transaction information of the first type by the first processing network to a second transaction system in the second processing network, where the second transaction system is able to complete the one or more transactions of the first type.

In another example, a method includes receiving, by a second processing network, transaction information associated with one or more transactions of a first type from a first processing network. The transaction information is obtained via an acquirer from one or more transactions of the first type at a transaction facilitator. Additionally, the method includes completing the one or more transactions of the first type by a second transaction system in the second processing network.

In a further example, a system may include a computing device. The computing device performs operations including receiving, by a transaction medium system, transaction information of a first type from an acquirer. The transaction information associated with one or more transactions of the first type is made at a transaction facilitator using a transaction medium. Additionally, the operations include determining that the transaction medium has migrated from a first processing network to a second processing network. The operations also include transferring the transaction information of the first type to a second transaction system in the second processing network. The second processing network is able to complete the one or more transactions of the first type.

### BRIEF DESCRIPTION OF THE DRAWINGS

FIG. 1 is a block diagram of a process for internally converting transactions according to one example of the present disclosure.

FIG. 2 is a flowchart of a process for internally converting transactions according to one example of the present disclosure.

FIG. 3 is a block diagram of a process for externally converting transactions according to one example of the present disclosure.

FIG. 4 is a flowchart of a process for externally converting transactions according to one example of the present disclosure.

FIG. 5 is a block diagram of a process for internally converting transactions according to one example of the present disclosure.

FIG. 6 is a block diagram of a batched process for internally converting transactions according to one example of the present disclosure.

FIG. 7 is an example of a computing environment for converting transactions according to one example of the present disclosure.

### DETAILED DESCRIPTION

Certain aspects and examples of the present disclosure relate to transaction system conversion techniques. One or more transactions can include transactions made by a user at a transaction facilitator using a transaction medium. Examples of the transaction facilitator may include a checkout system at a physical store, a checkout system at an online checkout system, an automated teller machine (“ATM”), or other suitable transaction point. The transaction medium can include a debit card, a credit card, a check, or other suitable medium. An internal switch of the transactions can occur via a first processing network and a second processing network. The first processing network may be associated with a first transaction medium system, and the second processing network may be associated with a second transaction medium system. The first transaction medium system may correspond to a first debit card system, while the second transaction medium system may correspond to a second debit card system. Transactions for the first processing network can be completed using a first transaction system in the first processing network for a user who has not transitioned from the first transaction medium system to the second transaction medium system. Alternatively, transactions for the first processing network can be completed using the second processing network for a user who has transitioned from the first payment processing network to the second payment processing network. Additionally or alternatively, transactions for the second payment processing network can be completed using the second transaction payment system.

The user can retain access to accounts and processing networks during the internal switch, which may provide less account downtime compared to downtime that may be experienced when a complete conversion from the first transaction medium system to the second transaction medium system occurs. Examples of bank services that the user can implement can include freezing the accounts, creating replacement accounts, or receiving account alerts. The complete conversion may involve transferring from the first transaction medium system to the second transaction medium system during a period of one day to three days. Additionally, the user can continue using the transaction medium associated with the first transaction medium system instead of immediately transitioning to the transaction medium associated with the second transaction medium system. For the complete conversion, the transaction medium associated with the second transaction medium system may be mailed to the bank clients, which may cause delays or errors in receiving the transaction medium associated with the second transaction medium system. Additionally, activating the transaction medium may cause large volumes of calls to a customer support phone line, high website traffic, or high client traffic in physical bank locations. The internal switch can be implemented in batches, which can ease traffic for customer service. For example, the internal switch can first be implemented for bank clients in a first state then for bank clients in a second state.

Transactions before the internal switch may be of a first type or of a second type. The transaction type may depend on an association of the transaction medium used for the transactions. The first transaction system can receive transactions of the first type that corresponds to the first transaction medium system that is associated with the first processing network. The first processing network can include a first network core that can maintain transaction medium information, such as a current balance of a bank account linked to the transaction medium. Additionally, the second processing network can receive transactions of the second type that correspond to the second transaction medium system. The second processing network can include a second network core that can maintain transaction medium information. The transaction medium issued after the internal switch may be of the second type.

The first processing network can include infrastructure to determine whether the transaction medium of the first type is a migrated transaction medium. For example, the first processing network can include a flagging system for migrated transaction mediums. An account associated with the migrated transaction medium may have migrated from the first processing network to the second processing network. Transactions for the migrated transaction medium can be switched from the first processing network to the second processing network via the internal switch. The internal switch can include communication between the first transaction system and the second transaction system to facilitate transferring the transactions. The communication may be facilitated by International Organization for Standardization (“ISO”) messaging or other suitable electronic communication.

Additionally, the first processing network can include enterprise data management module (EDM). The EDM can be used to monitor the transactions. For example, the EDM can intercept the transactions before the transactions reach the first transaction system and can determine whether transaction amounts for the transactions exceed a user-selected limit. The user-selected limit can be a numeral limit, such as fifty dollars. The EDM can cancel the transactions with transactions amounts that exceed the user-selected limit. Additionally, the EDM can transfer the transactions with transaction amounts that are equal to or below the user-selected limit to the first transaction system. A similar software can be implemented for the second processing network to block transactions that exceed the user-selected limit. Additionally or alternatively, the EDM can cancel transactions from a transaction facilitator that is included in a list of user-blocked merchants.

Additionally or alternatively, an external switch of the transactions can occur via a first transaction medium system and a second transaction medium system. The external switch can involve communication between the first transaction medium system and the second transaction medium system. The communication can include processor-to-processor migration or other suitable routing. The transactions of the first type can be transferred from the first transaction medium system to the second transaction medium system. The second transaction system in the second processing network can complete the transactions. Additionally, the second processing network can include the EDM to monitor transactions.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

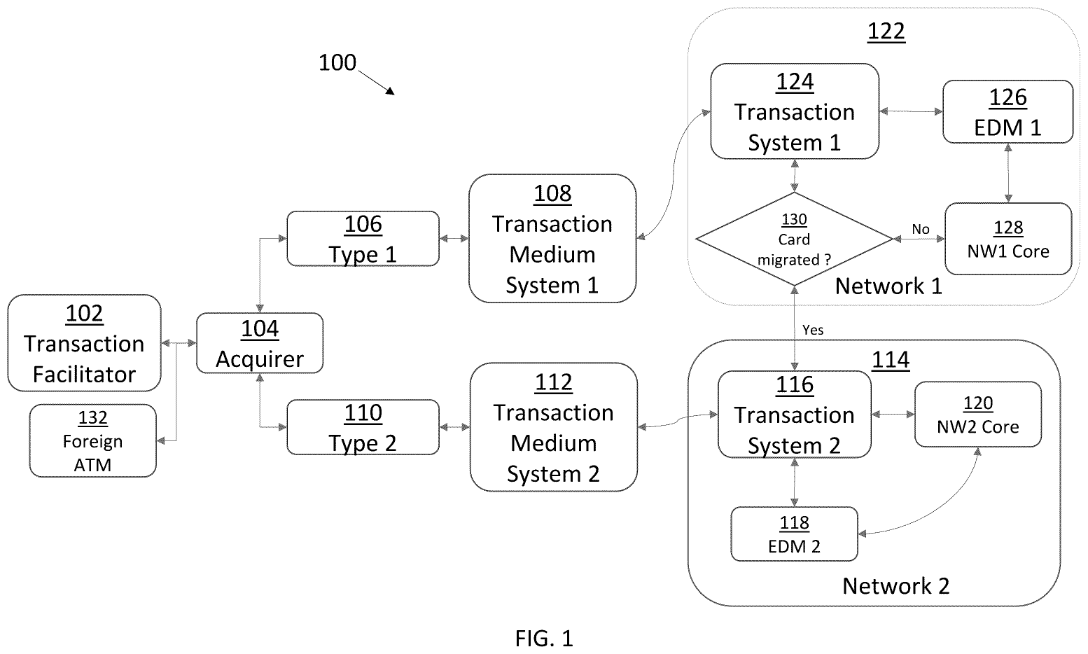

FIG. 1 is a block diagram of a process 100 for internally converting transactions according to one example of the present disclosure. The internal conversion can occur through a first transaction system 124 communicating with a second transaction system 116. The first transaction system 124 can be included in a first processing network 122, and the second transaction system 116 can be included in a second processing network 114. The communication between the first transaction system 124 and the second transaction system 116 can use electronic communication, such as ISO messaging. While FIGS. 1-7 are generally described with respect to debit cards, other card types, such as ATM cards or credit cards, may be also be used in the presently described techniques.

Bank clients can make one or more transactions at a transaction facilitator 102 using a transaction medium. The transaction medium can include a physical card or payment information of the physical card stored in a virtual wallet, such as Apple Wallet. The physical card can include a debit card, a credit card, or other suitable card linked with a financial account. Examples of a transaction facilitator 102 can include a checkout system at a physical store or a physical vendor. Further examples of the transaction facilitator 102 can include an online checkout system for a merchant or a vendor. Additionally, the transaction facilitator 102 can include an ATM or other suitable transaction point. An acquirer 104 can obtain transaction information regarding the one or more transactions from the transaction facilitator 102. The transaction information can include a transaction amount, an identifier for the transaction facilitator 102, a date and a time for the one or more transactions, and other suitable information related to the one or more transactions. Additionally or alternatively, the bank clients can make one or more transactions at a foreign transaction facilitator, such as a foreign ATM 132, using the transaction medium. Examples of the foreign ATM 132 can include ATMs operating with one or more bank systems that are not associated with a native bank system that issued the transaction medium. The acquirer 104 can receive transaction information regarding the one or more transactions from the foreign ATM 132.

A determination can be made regarding a type for the transaction medium and the corresponding transaction information for the transaction medium. The type can be determined to be a first type 106 or a second type 110. The transaction information of the first type 106 can be transferred from the acquirer 104 to a first transaction medium system 108. The first transaction medium system 108 can transfer the transaction information to a first transaction system 124 in the first processing network 122. The first processing network 122 can determine that the transaction medium has not migrated from the first processing network 122 to the second processing network 114. Accordingly, the first transaction system 124 can process the transaction information to complete the one or more transactions.

An enterprise data management module (“EDM”) 126 can intercept the transaction information before the first transaction system 124 processes the transaction information. The bank clients can set a user-selected limit for the transaction amount, such as a numeral limit of $200, by logging into their bank account. The bank clients can access their bank account through a desktop website, a mobile app, or other suitable access method. The EDM 126 can enforce the user-selected limit for the transaction amount by canceling one or more transactions that exceed the user-selected limit for the transaction amount. Additionally, the EDM 126 can cancel one or more transactions that have a transaction amount equal to the user-selected limit for the transaction amount. For further customization, the bank clients can create a list of user-blocked merchants by selecting one or more merchants to block transactions from. For example, a parent may choose to block a video game company to prevent a child from purchasing a video game from the video game company. The EDM 126 can determine that the transaction facilitator 102 for the one or more transactions is from the list of user-blocked merchants. To enforce the list of user-blocked merchants, the EDM 126 can cancel one or more transactions that have transaction information including the transaction facilitator 102 being on the list of user-blocked merchants.

The first processing network 122 can include a first network core 128. The first network core 128 can include computing infrastructure to maintain card-level information, such as a current balance in a bank account associated with the debit card. The first network core 128 can receive transaction information from the first transaction system 124. Using transaction information from the first network core 128, the EDM 126 can cancel one or more transactions that can be blocked according to one or more limits set by the bank clients, as described above. Additionally or alternatively, the EDM 126 can use the card-level information from the first network core 128 to decide whether to cancel the one or more transactions.

A determination 130 can be made regarding a migration status of the transaction medium. The transaction medium of the first type can have a positive migration status, which indicates that the transaction medium of the first type 106 has migrated from transaction processing being performed by the first processing network 122 to being performed by the second processing network 114. Transaction information for a migrated transaction medium can be transferred by the first transaction system 124 to the second processing network 114. The second transaction system 116 in the second processing network 114 can receive the transaction information for the migrated transaction medium. The second transaction system 116 can complete the one or more transactions associated with the migrated transaction medium of the first type 106. The second transaction system 116 can include a second network core 120. The second network core 120 can maintain transaction medium information for transaction mediums of the second type 110. Additionally, the second transaction system 116 can include a second EDM 118 to monitor the one or more transactions. The second EDM 118 can cancel a subset of the one or more transactions that are blocked based on user-generated limits, such as a numeral limit for the transaction amount or the list of user-block merchants.

Alternatively, the transaction medium of the first type 106 can have a negative migration status, which indicates that the transaction medium of the first type has not migrated from the first processing network 122. For example, the bank clients may not have activated a transaction medium of the second type 110 that was issued to replace the transaction medium of the first type 106. The bank clients may continue to use the transaction medium of the first type 106 before activating the transaction medium of the second type 110 that has been issued. The transaction information for the transaction medium of the first type 106 that has not migrated can be transferred to the first processing network 122. The first transaction system 124 in the first processing network 122 can complete the one or more transactions associated with the transaction medium of the first type 106 that has not migrated.

Additionally or alternatively, the transaction information for the second type 110 can be transferred from the acquirer 104 to a second transaction medium system 112. The second transaction medium system 112 can transfer the transaction information for the second type 110 to the second processing network 114. In the second processing network 114, the second transaction system 116 can complete the one or more transactions for the second type 110. Alternatively, the second EDM 118 can cancel a subset of the one or more transactions that fulfill one or more criteria before they reach the second transaction system 116. The one or more criteria can include the user-generated limits, such as a numeral limit for the transaction amount.

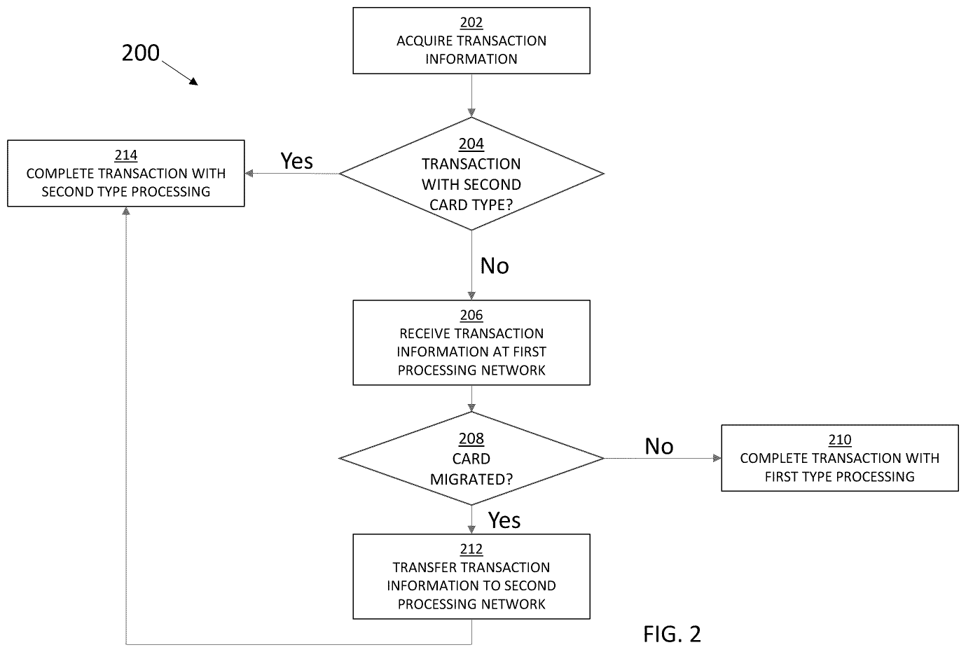

FIG. 2 is a flowchart of a process 200 for internally converting transactions according to one example of the present disclosure. FIG. 2 is described with references to components shown in FIG. 1.

At block 202, the process 200 can involve acquiring transaction information from one or more transactions made by a user with a transaction medium. The transaction information can include information regarding one or more transactions that were made using a debit card. An acquirer 104 can obtain the transaction information from a transaction facilitator 102, such as a native ATM or a foreign ATM 132. The native ATM can include an ATM associated with a native banking system that issued the transaction medium. The foreign ATM 132 can include an ATM associated with a foreign banking system that did not issue the debit card. The transaction facilitator 102 can include vendors at physical locations, such as grocery stores, or online vendors. Examples of the transaction information can include date and time of the one or more transactions, an identifier for the transaction facilitator 102, or other suitable information related to the one or more transactions.

At block 204, the process 200 can involve determining a type used for the one or more transactions. The type may include a first type 106 or a second type 110. The first type 106 can be associated with a first transaction medium system 108. The second type 110 can be associated with a second transaction medium system 112. The acquirer 104 can determine the type for the one or more transactions. Additionally, the acquirer 104 can transfer the transactions of the first type to the first transaction medium system 108 and can transfer the transactions of the second type to the second transaction medium system 112.

At block 206, the process 200 can involve receiving the transaction information of one or more transactions of the first type 106 at a first processing network 122. The first processing network 122 can receive the transactions of the first type 106 from the first transaction medium system 108. The first processing network 122 can include an EDM 126 to monitor the one or more transactions for the first type 106. Additionally or alternatively, the first processing network 122 can include a first network core 128 to maintain the transaction medium information.

At block 208, the process 200 can involve determining a migration status of the transaction medium of the first type 106. The migration status of the transaction medium can include a positive migration status or a negative migration status. The positive migration status can indicate that the transaction medium has migrated from the first processing network 122 to the second processing network 114. The negative migration status can indicate that the transaction medium has not migrated from the first processing network 122 to the second processing network 114. The first processing network 122 can include computing infrastructure to determine the migration status of the transaction medium. For example, the first processing network 122 can include a transaction medium management system that can flag transaction mediums of the first type 106 with the negative migration status.

At block 210, the process 200 can involve completing the one or more transactions of the first type 106 using a first transaction system 124 in a first processing network 122. A determination can be made that the transaction medium has the negative migration status before the first transaction system 124 completes the one or more transactions. The EDM 126 in the first processing network 122 can cancel a portion of the one or more transactions that fulfill the one or more criteria. The EDM 126 can communicate with the first network core 128 in the first processing network 122 to use the transaction medium information in a process of canceling the portion of the one or more transactions that fulfill the one or more criteria.

At block 212, the process 200 can involve transferring the transaction information of one or more transactions for the first type 106 to a second processing network 114. A determination can be made that the transaction medium of the first type 106 has the positive migration status before transferring the transaction information. The one or more transactions associated with the transferred transaction information can be completed by a second transaction system 116 in a second processing network 114, as described below for block 214.

At block 214, the process 200 can involve completing the one or more transactions using the second transaction system 116 in the second processing network 114. The second transaction system 116 can complete the one or more transactions for the first type 106 or one or more transactions for the second type 110. The transaction information for the second type 110 can be transferred from the second transaction medium system 112 to the second transaction system 116. The transaction information for the first type 106 can be transferred from the first processing network 122 to the second transaction system 116 in the second processing network 114. Additionally, the second processing network 114 can include a second EDM 118. The second EDM 118 can monitor the one or more transactions. The second EDM 118 additionally can block a subset of the one or more transactions that fulfill one or more criteria. The one or more criteria can be set by bank clients via a website for the native banking system, an app for the native banking system, a phone call via a customer service phone line for the native banking system, or at a physical bank location. Additionally or alternatively, the second processing network 114 can include a second network core 120. The second network core 120 can store or maintain transaction medium information, such as an available balance associated with the transaction medium and a bank account coupled to the transaction medium. The second network core 120 and the second EDM 118 can be communicatively coupled.

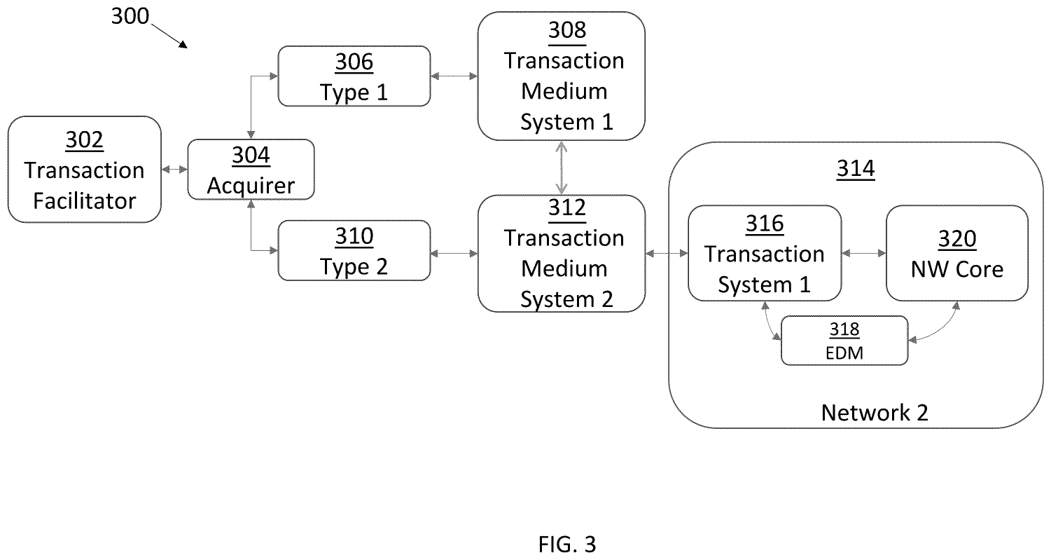

FIG. 3 is a block diagram of a process 300 for externally converting transactions according to one example of the present disclosure. An acquirer 304 can obtain transaction information for one or more transactions generated at a transaction facilitator 302. The one or more transactions can be made by bank clients using a debit card or other suitable transaction medium. The transaction facilitator 302 can include an online vendor or a vendor at a physical location. The transaction information can include information regarding a date and a time of the one or more transactions, an identifier for the transaction facilitator 302, a transaction amount, or other suitable information related to the one or more transactions.

The acquirer 304 can determine a type for the transaction medium used for the one or more transactions. The type can include a first type 306 and a second type 310. The transaction information for the first type 306 can be transferred to a first transaction medium system 308. The transaction information for the second type 310 can be transferred to a second transaction medium system 312. The first transaction medium system 308 and the second transaction medium system 312 can be communicatively coupled. Additionally, the first transaction medium system 308 can transfer the transaction information for the first type 306 to the second transaction medium system 312.

The transaction information for the second type 310 can be transferred to the second transaction medium system 312 from the acquirer 304. A processing network 314 can receive the transaction information from the second transaction medium system 312. The processing network 314 can include a transaction system 316. The transaction system can complete the one or more transactions of the first type 306 and can complete the one or more transactions of the second type 310. Additionally, the processing network 314 can include an EDM 318. The EDM 318 can monitor the transaction information for the one or more transactions. The EDM 318 additionally can cancel a group of one or more transactions that fulfill one or more criteria related to one or more limits set by a bank client. In the processing network 314, a network core 320 can be used to maintain transaction medium information. The network core 320 can communicate with the EDM 318 to provide transaction medium information to the EDM 318.

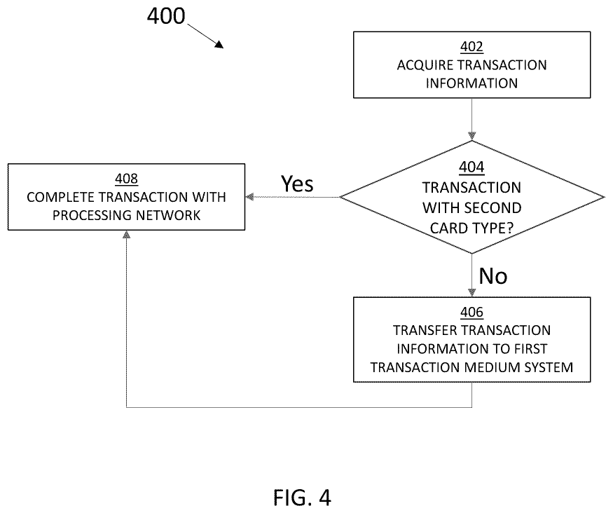

FIG. 4 is a flowchart of a process 400 for externally converting transactions according to one example of the present disclosure. FIG. 4 is described with references to FIG. 3.

At block 402, the process 400 can involve acquiring transaction information for one or more transactions made by a user, such as a bank client, with a transaction medium. The one or more transactions can be generated at a transaction facilitator 302 by the bank client using a debit card or other suitable transaction medium. The transaction information can be obtained by an acquirer 304. Examples of the transaction information can include a category for the one or more transactions and a transaction amount for the one or more transactions. The category for the one or more transactions can include food, entertainment, shopping, or other suitable label.

At block 404, the process 400 can involve a determination being made regarding a type of the transaction medium. The acquirer 304 can determine the type of the transaction medium. The type can include a first type 306 or a second type 310. The first type 306 can be associated with a first transaction medium system 308. The second type 310 can be associated with a second transaction medium system 312.

At block 406, the process 400 can involve transferring the transaction information for the first type 306 to a second transaction medium system 312. The transaction information for the first type 306 can be transferred from the acquirer 304. The first transaction medium system 308 can be communicatively coupled to the second transaction medium system 312. The second transaction medium system 312 can be communicatively coupled to the transaction system 316 in the processing network 314. The transaction information for the first type 306 can be transferred from the first transaction medium system 308 to the second transaction medium system 312. Additionally, the transaction information for the first type 306 can be transferred by the second transaction medium system 312 to the transaction system 316. The transaction system 316 in a processing network 314 can complete the one or more transactions for the first type, as described below for block 408.

At block 408, the process 400 can involve completing the one or more transactions using the transaction system 316 in the processing network 314. The transaction system 316 can complete the one or more transactions of the first type 306 and the one or more transactions of the second type 310. Before the transaction system 316 completes the one or more transactions, an EDM 318 in the processing network 314 can cancel a subset of the one or more transactions that fulfill one or more criteria. The one or more criteria can be set by the bank client. The EDM 318 can receive transaction medium information from a network core 320 in the processing network 314.

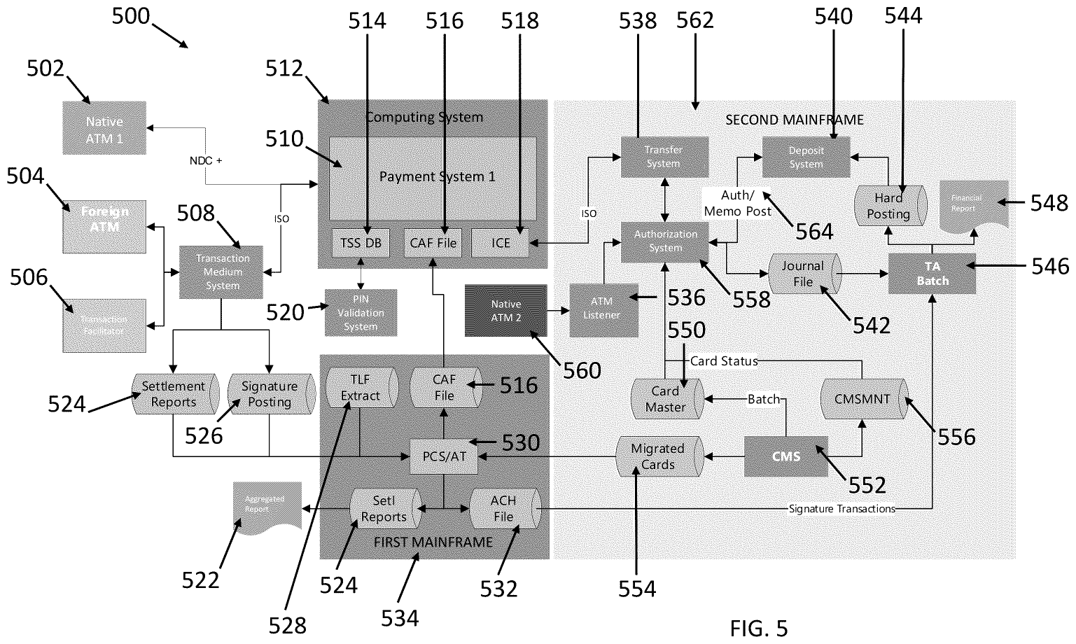

FIG. 5 is a block diagram of a process 500 for internally converting transactions according to one example of the present disclosure. The process 500 can involve internally converting one or more transactions for a transaction medium, such as a debit card, from a first processing network to a second processing network. The first processing network can be a first banking system, and the second processing network can be a second banking system.

A user, such as a bank client, can generate one or more card transactions using the debit card. The bank client can generate the one or more card transactions at a transaction facilitator. Examples of the transaction facilitator can include a first native ATM 502, a second native ATM 560, a foreign ATM 504, a point of sale (“POS”) 506, or other suitable transaction point. The first native ATM 502 can include ATMs that are associated with a first native banking system. The second native ATM 560 can include ATMs that are associated with a second native banking system. The first native banking system and the second native banking system can be associated with a combined banking system. The combined banking system can result from a merger, an acquisition, or other suitable combination of one or more banking systems. The foreign ATM 504 can be associated with a foreign banking system that is not related to the native banking system.

Transaction information can be obtained from the one or more card transactions. The transaction information can include a date and a time of the one or more card transactions, an identifier for an origin of the one or more card transactions, or other suitable information relevant to the one or more card transactions. The transaction information from the foreign ATM 504 or the transaction facilitator 506 can be received by a debit processing system 508. The debit processing system 508 can additionally receive transaction information for the first native ATM 502 via electronic communication. The electronic communication can include ISO messaging. From the received transaction information, the debit processing system 508 can generate one or more settlement reports 524. Additionally or alternatively, the debit processing system 508 can generate a signature posting 526 from the received transaction information. The signature posting 526 can include a posting generated from a card transaction that was validated using a signature from the bank client.

A first computing mainframe 534 can receive the one or more settlement reports 524 or the signature posting 526 from the debit processing system 508. The first computing mainframe 534 can be associated with the first native banking system. A network core 530 in the first computing mainframe 534 can process the one or more settlement reports 524. Additionally, the network core 530 can generate an aggregated report 522, using the one or more settlement reports 524. The aggregated report 522 can be transmitted from the first computing mainframe 534 to an outside recipient. The network core 530 additionally can receive an extract report 528 that can be generated in the first computing mainframe. The extract report 528 can be generated by an extraction system and can include one or more log files, such as time library format (“TLF”) files. A record file 532, such as an automated clearing house (“ACH”) file, can be generated by the debit processing system 508. The record file 532 can include one or more batches, where the one or more batches can include the transaction information for the one or more card transactions. Additionally, the record file 532 can be transferred from the debit processing system 508 to a batched system 546. The record file 532 can include one or more signature transactions. The one or more signature transactions can include one or more card transactions that are processed with the bank client signing a receipt for the one or more card transactions instead of entering a personal identification number (“PIN”).

The network core 530 can generate a central file 516, using information from the one or more settlement reports 524, the signature posting 526, the extract report 528, or a combination thereof. The central file 516 can be transferred from the network core 530 to a computing system 512. The computing system 512 can include a first transaction payment system 510. The first transaction payment system 510 can be associated with the first native banking system. Additionally, the computing system 512 can include a database 514, such as a TSS database. The database 514 can contain PIN information that can be used by a PIN validation system 520, such as a PIN validation system that uses Atalla hardware security modules (“HSMs”). The PIN validation system 520 can validate the one or more card transactions based on the PIN entered for the one or more card transactions. The PIN validation system 520 can be positioned outside of the computing system 512. The computing system 512 additionally can include a communication system 518. The communication system 518 can communicate the transaction information to a transfer system 538. The communication between the communication system 518 and the transfer system 538 can occur using ISO messaging or other suitable electronic communication.

The transaction information from the second native ATM 560 can be received by an ATM listener 536. The ATM listener 536 can be associated with the second native banking system. The second native banking system can include a second computing mainframe 562. The second computing mainframe 562 can be incorporated into a combined computing mainframe for the combined banking system. The transfer system 538 may be included in the second computing mainframe 562. Additionally, the transfer system 538 can be communicatively coupled with an authorization system 558 that can receive transaction information from the ATM listener 536. The authorization system 558 can generate one or more journal files 542 that can be transferred to the batched system 546. The one or more journal files 542 can contain the transaction information, financial information, or a combination thereof.

Additionally, the second computing mainframe 562 can include a card management system 552. The card management system 552 can maintain card-level information. The card-level information can include migration status, authorization status, or other suitable card information. The network core 530 in the first computing mainframe 534 can receive information from the card management system 552. The information can include data related to migrated cards 554. Additionally, the card management system 552 can be communicatively coupled to a card maintenance system 556. The card maintenance system 556 can pass the authorization status from the card management system 552 to the authorization system 558. The authorization system 558 can use the authorization status to determine allowance of the one or more card transactions. Additionally or alternatively, the card management system 552 can include a card master system 550. The card master system 550 can pass card-related information from the card management system 552 to the authorization system 558.

Additionally or alternatively, the authorization system 558 can generate one or more authorization posts 564. The one or more authorization posts 564 may include memo-posting. The memo-posting can involve generating temporary entries for a banking account that are removed after end-of-day batch processing updates an account balance for the banking account. For example, a group of one or more card transactions can be memo-posted as one or more charges to the banking account to prevent an overdraw of the account balance from later card transactions. Additionally or alternatively, the batched system 546 can generate a financial report 548, such as a Mobius report.

The one or more authorization posts 564 can be used by a deposit system 540. The deposit system 540 can be associated with the second native banking system. Additionally, the deposit system 540 can receive posting information 544 from the batched system 546. The posting information 544 can include hard posting information that can be generated from end-of-day batch processing. The end-of-day batch processing can be implemented by the batched system 546.

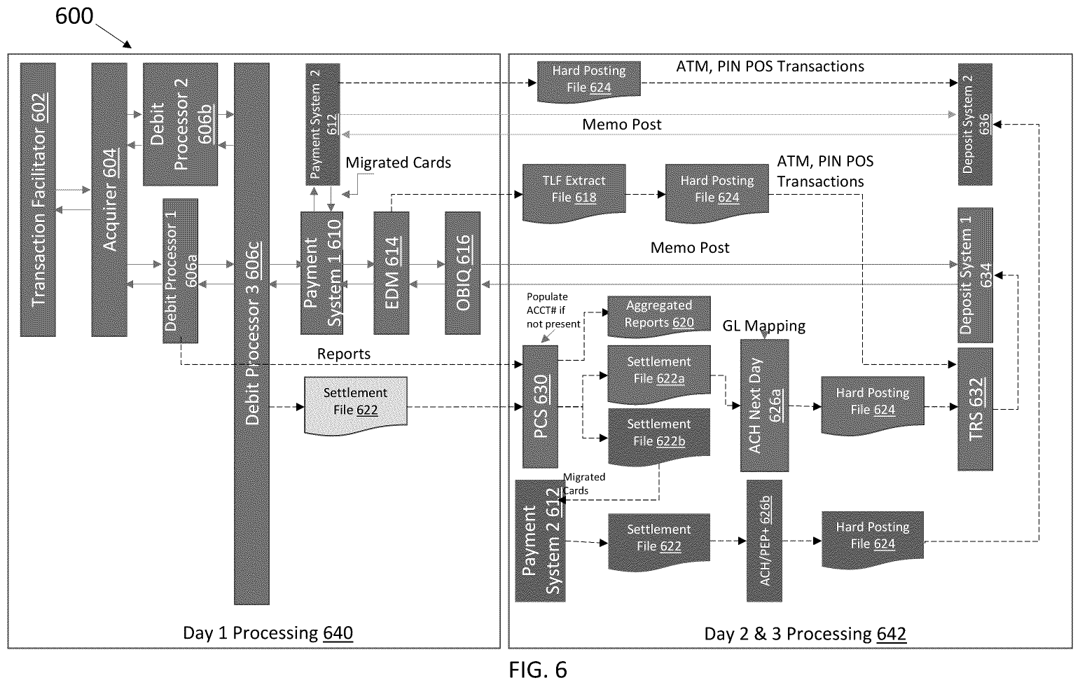

FIG. 6 is a block diagram of a batched process 600 for internally converting bank account transactions according to one example of the present disclosure. The batched process 600 can include a method of running software programs in batches automatically. For example, in banking systems, batch processing can be implemented to process multiple transactions in a group. Batch processing can be a cost-effective technique to handle large amounts of data at once. Additionally, the batched process 600 can be implemented with early processing 640, later processing 642, or a combination thereof. The early processing 640 can occur for processing on a first day, while the later processing 642 can occur for processing on a second day or a third day.

As a part of the early processing 640, a merchant processor 602 can initiate one or more card transactions from a debit card used by a bank client. An acquirer 604 can receive the one or more card transactions and can generate transaction information regarding the one or more card transactions. A debit processing system can receive the transaction information transferred from the acquirer 604. The debit processing system can have at least one debit processor 606a-c. For example, the debit processing system can include a first debit processor 606a, a second debit processor 606b, and a third debit processor 606c. The first debit processor 606a and the second debit processor 606b can receive the transaction information from the acquirer 604. Additionally, the second debit processor 606b can generate one or more reports using the transaction information. The third debit processor 606c can receive the transaction information transferred from the first debit processor 606a, the second debit processor 606b, or a combination thereof. Additionally, the third debit processor 606c can generate one or more settlement files 622 using the transaction information. A second network core 630 can receive the one or more settlement files 622, the one or more reports, or a combination thereof for the later processing 642.

A first transaction payment system 610 can transmit the transaction information received from the third debit processor 606c to a second transaction payment system 612. As a part of the later processing 642, the second transaction payment system 612 can generate a hard posting file 624 that is received by a second deposit system 636. The second deposit system 636 can be associated with a second banking system. A first deposit system 634 can be associated with a first banking system. The first banking system and the second banking system can be related due to a merger, an acquisition, or other suitable combination of banking systems.

Additionally or alternatively, the first transaction payment system 610 can transmit the transaction information received from the third debit processor 606c to an EDM 614. The EDM 614 can monitor the transaction information to cancel a subset of the one or more card transactions that fulfill one or more criteria. The one or more criteria can be inputted by the bank client to generate transactions limits. The transaction limits can include a numeral limit for a transaction amount, a blocked vendor, or other suitable limits to a debit card transaction. In the later processing 642, the EDM 614 can generate an extract file 618, such as a TLF extract file, from the transaction information. The extract file 618 can include log file information regarding the transaction information. A hard posting file 624 can be created from the extract file 618 and can be received by a transfer system 632. The hard posting file 624 can indicate that the one or more card transactions have been finalized. Additionally, the hard posting file 624 can include information for one or more card transactions originating from an ATM or a transaction facilitator where the bank client inputted a PIN.

Further, the EDM 614 can transfer the transaction information to a network core 616. The network core 616 can maintain card-level information, such as an account balance for a bank account associated with the debit card. The network core 616 can process the transaction information for the one or more card transactions from the EDM 614 to add to or subtract from the account balance based on the transaction information. In the later processing 642, the network core 616 can generate a memo post that is received by the first deposit system 634. The memo post can provide notice regarding the one or more card transactions. Additionally, the memo post can be a temporary post that can be removed after end-of-day batch processing updates the bank account.

The second network core 630 can process the one or more settlement files 622 to separate the one or more settlement files 622 based on a type difference for the one or more transactions, such as a card type. Additionally, the second network core 620 can populate an account number for the one or more card transactions if the account number is not present. The card type can be a first card type or a second card type. The one or more settlement files for the first card type 622a can be transmitted by the second network core 630 to a first record file system 626a. The first record file system 626a can settle the one or more card transactions on a next business day after the one or more card transactions are received by the first record file system 626a. Additionally, the first record file system 626a can incorporate a method for assigning the account number to the one or more card transactions. An example of the method can include general ledger mapping that assigns a general ledger account number to the one or more card transactions. The first record file system 626a can generate the hard posting file 624 using the one or more settlement files for the first card type 622a. The transfer system 632 can process the hard posting file 624 to transmit the transaction information to the first deposit system 634.

The one or more settlement files for the second card type 622b can be transmitted from the second network core 630 to the second transaction payment system 612. The second transaction payment system 612 can transmit the one or more settlement files for the second card type 622b to a second record file system 626b. The second record file system 626b can use a mainframe system, such as PEP+, that can allow automatic reception and origination for electronic payments for the second record file system. The second record file system 626b can generate the hard posting file 624 from the one or more settlement files for the second card type 622b. The hard posting file 624 can be transmitted to the second deposit system 626.

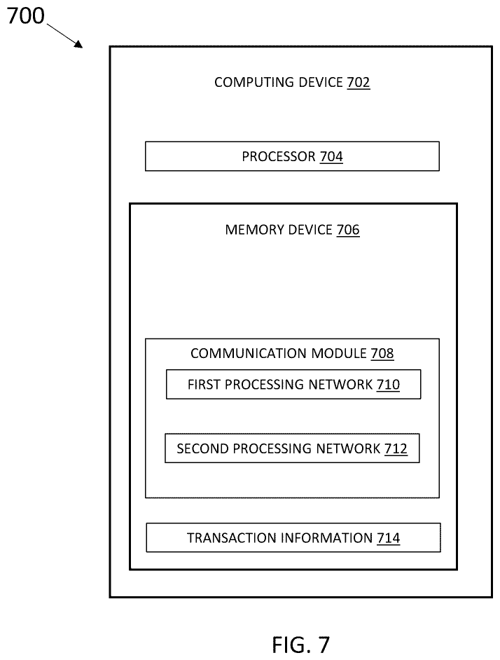

FIG. 7 is an example of a computing environment 700 according to one example of the present disclosure. The components shown in FIG. 7 may be integrated into a single structure, such as within a single housing of the computing device. Alternatively, the components shown in FIG. 7 may be distributed from the other components and in electrical communication with the other components. The computing device 702 can include a server, such as a cloud computing server. The computing device 702 can include a memory device 706 that can be a non-transitory computer-readable medium. The memory device 706 can store instructions that can be executed by a processor in the computing device 702. The computing device 702 can include a processor 704 that can be communicatively coupled to the memory device 706. The memory device 706 can include instructions that can be executable by the processor 704 for causing the processor 704 to perform operations.

The processor 704 can include one processor or multiple processors. Additionally, the processor 704 can be a processing device. Non-limiting examples of the processor 704 include a Field-Programmable Gate Array (FPGA), an application-specific integrated circuit (ASIC), a microprocessor, etc. The processor 704 can execute instructions stored in the memory device 706 to perform one or more operations. In some examples, the instructions can include processor-specific instructions generated by a compiler or an interpreter from code written in any suitable computer-programming language, such as C, C++, C #, etc.

For example, the processor 704 can use a communication module 708 stored in the memory device 706 to communicate between a first processing network 710 and a second processing network 712. Through the communication module 708, the processor 704 can convert one or more transactions from the first processing network 710 to the second processing network 712. The one or more transactions can be generated by a bank client using a transaction medium, such as a debit card. Additionally, the one or more transactions can have transaction information 714 associated with the one or more transactions. The processor 704 can use transaction information 714 stored in the memory device 706 to make determinations regarding a migration status of the transaction medium, a card type, or other suitable determinations for the debit card. The migration status can indicate whether the transaction medium has migrated from the first processing network 710 to the second processing network 712. The card type, the migration status, or a combination thereof can be used by the processor 704 to determine a route for the transaction information.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A non-transitory computer-readable medium comprising instructions that are executable by a processing device for causing the processing device to perform operations comprising:
receiving, by a first processing network, transaction information associated with one or more transactions of a first type from a transaction medium system, the transaction information obtained by the transaction medium system from an acquirer at a transaction facilitator;
determining that a transaction medium associated with the one or more transactions of the first type has migrated from the first processing network to a second processing network; and
transferring, by the first processing network, the transaction information of the first type to a second transaction system in the second processing network, the second transaction system completing the one or more transactions of the first type.

2. The non-transitory computer-readable medium of claim 1, wherein the operations further comprise:
processing, by a network core in the first processing network, the transaction information associated with the one or more transactions of the first type to generate one or more authorization posts; and
receiving, by a first deposit system in the first processing network, the one or more authorization posts to complete the one or more transactions of the first type.

3. The non-transitory computer-readable medium of claim 1, wherein the operations further comprise:
determining that the transaction medium has not migrated from the first processing network to a second processing network; and
completing, by a first transaction system in the first processing network, the one or more transactions of the first type.

4. The non-transitory computer-readable medium of claim 1, wherein the operations further comprise:
obtaining, by an enterprise data management module (EDM) in the first processing network, the transaction information associated with the one or more transactions of the first type before the one or more transactions of the first type are completed by a first transaction system;
determining that a transaction amount in the transaction information of the one or more transactions of the first type exceeds a user-selected limit; and
canceling the one or more transactions of the first type that are associated with the transaction amount.

5. The non-transitory computer-readable medium of claim 1, wherein the operations further comprise:
obtaining, by an enterprise data management module (EDM) in the first processing network, the transaction information associated with the one or more transactions of the first type before the one or more transactions of the first type are completed by a first transaction system;
determining that the transaction facilitator of the one or more transactions of the first type is from a list of user-blocked merchants; and
canceling the one or more transactions of the first type.

6. The non-transitory computer-readable medium of claim 1, wherein the operations further comprise:
receiving, via a network core in the first processing network, transaction medium information of one or more migrated transaction mediums from a management system in the second processing network; and
processing, via the network core, the transaction medium information of the one or more migrated transaction mediums to generate one or more settlement files that the second transaction system receives, the second transaction system completing the one or more transactions of the first type.

7. The non-transitory computer-readable medium of claim 1, wherein the operations further comprise:
transmitting, by a network core in the first processing network, one or more record files to a batched process in the second processing network, wherein the one or more transactions are completed during the batched process.

8. A computer-implemented method comprising:
receiving, by a second processing network, transaction information associated with one or more transactions of a first type from a first processing network, the transaction information obtained via an acquirer from one or more transactions of the first type at a transaction facilitator; and
completing, by a second transaction system in the second processing network, the one or more transactions of the first type.

9. The computer-implemented method of claim 8, further comprising:
receiving, by the second processing network, one or more transactions of a second type from a transaction medium system, the transaction information obtained by the acquirer from the one or more transactions of the second type at the transaction facilitator; and
completing, by the second transaction system, the one or more transactions of the second type, wherein completing the one or more transactions of the second type further comprise:
processing, by a network core in the second processing network, the transaction information associated with the one or more transactions of the second type to generate one or more authorization posts; and
receiving, by a second deposit system in the second processing network, the one or more authorization posts to complete the one or more transactions of the second type.

10. The computer-implemented method of claim 8, further comprising:
obtaining, by an enterprise data management module (EDM) in the second processing network, the transaction information associated with the one or more transactions of the first type before being completed by the second transaction system;
determining a transaction amount in the transaction information exceeds a user-selected limit; and
canceling the one or more transactions of the first type.

11. The computer-implemented method of claim 8, further comprising:
obtaining, by enterprise data management module (EDM) in the second processing network, the transaction information associated with the one or more transactions of the first type before being completed the second transaction system;
determining the transaction facilitator is from a list of user-blocked merchants; and
canceling the one or more transactions of the first type.

12. The computer-implemented method of claim 8, further comprising:
receiving, by the first processing network, the transaction information associated with the one or more transactions of the first type from a transaction medium system;
determining that a transaction medium associated with the one or more transactions of the first type has migrated from the first processing network to the second processing network; and
transferring, by the first processing network, the transaction information of the first type to the second transaction system in the second processing network.

13. The computer-implemented method of claim 12, further comprising:
receiving, by the first processing network, the transaction information associated with the one or more transactions of the first type to generate one or more authorization posts; and
receiving, by a first deposit system in the first processing network, the one or more authorization posts to complete the one or more transactions of the first type.

14. A system comprising:
a processing device; and
a non-transitory computer-readable medium comprising instructions that are executable by a processing device for causing the processing device to:
receive, by a transaction medium system, transaction information of a first type from an acquirer, the transaction information associated with one or more transactions of the first type made at a transaction facilitator using a transaction medium;
determine that the transaction medium has migrated from a first processing network to a second processing network; and
transfer the transaction information of the first type to a second transaction system in the second processing network, the second transaction system completing the one or more transactions of the first type.

15. The system of claim 14, wherein the non-transitory computer-readable medium further includes instructions executable by the processing device for causing the processing device to:
receive, by the transaction medium system, transaction information of a second type from the acquirer, the transaction information associated with one or more transactions of the second type from the transaction facilitator; and
transfer, by the second transaction medium system, the transaction information from the acquirer to the second transaction system, the second transaction system completing the one or more transactions of the second type.

16. The system of claim 14, wherein the non-transitory computer-readable medium further includes instructions executable by the processing device for causing the processing device to:
determine that the transaction medium of the first type has not migrated from the first processing network to a second processing network; and
transfer, by the transaction medium system, the transaction information to a first transaction system in the first processing network, the first transaction system completing the one or more transactions of the first type.

17. The system of claim 14, wherein the non-transitory computer-readable medium further includes instructions executable by the processing device for causing the processing device to:
obtaining, from an enterprise data management module (EDM) of the transaction medium system, the transaction information of the first type before being completed by the first transaction system;
determine that a transaction amount in the transaction information of the first type exceeds a user-selected limit; and
cancel the one or more transactions of the first type that are associated with the transaction amount.

18. The system of claim 14, wherein the non-transitory computer-readable medium further includes instructions executable by the processing device for causing the processing device to:
obtaining, by an enterprise data management module (EDM) of the transaction medium system, the transaction information of the first type before being completed the first transaction system;
determine that the transaction facilitator is from a list of user-blocked merchants; and
cancel the one or more transactions of the first type.

19. The system of claim 14, wherein the non-transitory computer-readable medium further includes instructions executable by the processing device for causing the processing device to:
transfer, by the transaction medium system, the transaction information of the first type from the acquirer to a second transaction medium system; and
transfer, by the second transaction medium system, the transaction information of the first type from the first transaction medium system to the second transaction system, the second transaction system completing the one or more transactions of the first type.

20. The system of claim 14, wherein the non-transitory computer-readable medium device further includes instructions executable by the processing device for causing the processing device to:
receive, by the transaction medium system, transaction information from an acquirer, the transaction information associated with one or more transactions from a foreign transaction facilitator;
generate, by the transaction medium system, one or more settlement files associated with the one or more transactions from the foreign transaction facilitator; and
transfer, by the transaction medium system, the one or more settlement files to a network core in the first processing network, the network core processing the one or more settlement files to generate one or more central files to send to the second processing network for completion of the one or more transactions from the foreign transaction facilitator.
